(19) United States
(12) Patent Application Publication
(10) Pub. No.: US 2007/0067502 A1
(43) Pub. Date: Mar. 22, 2007

(54) Method for preventing long latency event

(75) Inventor: Te-Lin Ping, Tao-Yuan (TW)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(73) Assignee: SILICON INTEGRATED SYSTEMS CORP.

(21) Appl. No.: 11/233,590

(22) Filed: Sep. 22, 2005

(51) Int. Cl. G06F 3/00

(52) U.S. Cl. 710/15

(57) ABSTRACT

A method for preventing the long latency event in the working procedure of the processor is disclosed, wherein the method comprises one step of checking whether a status happens or not. When the status happens, the processor would release the resource for specific time duration to process other works in order to prevent the long latency event.

### BACKGROUND OF THE INVENTION

1. Field of the Invention

The present invention generally relates to a method for preventing long latency event, and specifically relates to a method for preventing long latency event in working procedure of the processor.

2. Description of the Prior Art

In the present working procedure of the processor, it is very important to arrange the order of different works when several works have to be processed by the processor. When several works have to be processed in a processor, it is very common to process the urgent works at first, and then process the other works.

As the above-mentioned description, the distinction of work urgency is related to the concept of priority in the conventional technique. For the important works, the processor would assign the higher priority to lead the works to be processed earlier; on the other hand, the processor would assign the less priority to lead the general works to be processed later. It is quite obvious that the processor would assign the highest priority to the most important works in order to complete these works first by the most of the processor computing resource.

In the conventional technique, some of the most important works would be processed when a specific status happens. If the specific status can't be satisfied in short time and then all the works in the processor would be delay, which is called “long latency event”.

FIG. 1 shows a flow chart of the work procedure in conventional processor. In the step 100, the driver for driving processor is enabled at first. In the step 103, the driver repeatedly checks whether an event happens or not, and then enters next step until the event has happened. The called event refers to the work that will be performed in the processor. In general, since the works asked by the driver in computer system are more important than others, the computer system would process other works after the works asked by the driver had been completed. When the event has happened, the delay procedure 106 would be performed. The purpose of the delay procedure 106 is to make the processor to process a loop. The purpose of processing a loop is to wait for a time, and look forward to the happening of a status. The called status refers to an essential condition. The foregoing event should be performed when the status has happened. Furthermore, the foregoing event and status would be dilated in the following contents.

After the delay procedure 106 is finished, the step 109 of polling status would be performed. If the status has happened in step 109, and then the step 112 would be executed to perform the event destination function to process the event by the processor. Next, the working procedure would enter the step 115 of processing driver other function, and then return to the step 103 finally. However, if the status has not happened in step 109, the working procedure would return to the step 106.

According to the above-mentioned description, the computing performance of the processor would be repeatedly expended in the step 106 if the status has not happened in the step 109, and then leads to the “long latency event”.

Due to the foregoing long latency event in conventional working procedure, the processor can not process other works. Hence, it is important to provide a novel method for preventing the long latency event in the working procedure of the processor. According to the novel method, the processor could release the computing performance to process other works when the long latency event happens.

### SUMMARY OF THE INVENTION

In view of the foregoing, it is one object of the present invention to provide a method for temporary releasing the resource of the processor to prevent the long latency event.

It is another object of the present invention to provide a method for processor to process the work so as to prevent the long latency event.

According to one embodiment of the present invention, a method for preventing the long latency event in the working procedure of the processor is disclosed. The method comprises the steps of: (a) repeatedly checking whether an event happens or not; (b) performing a delay procedure during a first time duration when the event happens; (c) checking whether a status happens or not; (d) performing a resource releasing procedure during a second time duration to a processor to process a first work when the status didn't happen in step (c), and then return to step (b).

### BRIEF DESCRIPTION OF THE DRAWINGS

The foregoing aspects and many of the attendant advantages of this invention would become more readily appreciated as the same becomes better understood by reference to the following detailed description, when taken in conjunction with the accompanying drawings, wherein:

FIG. 1 shows a flow chart of the conventional working procedure of the processor;

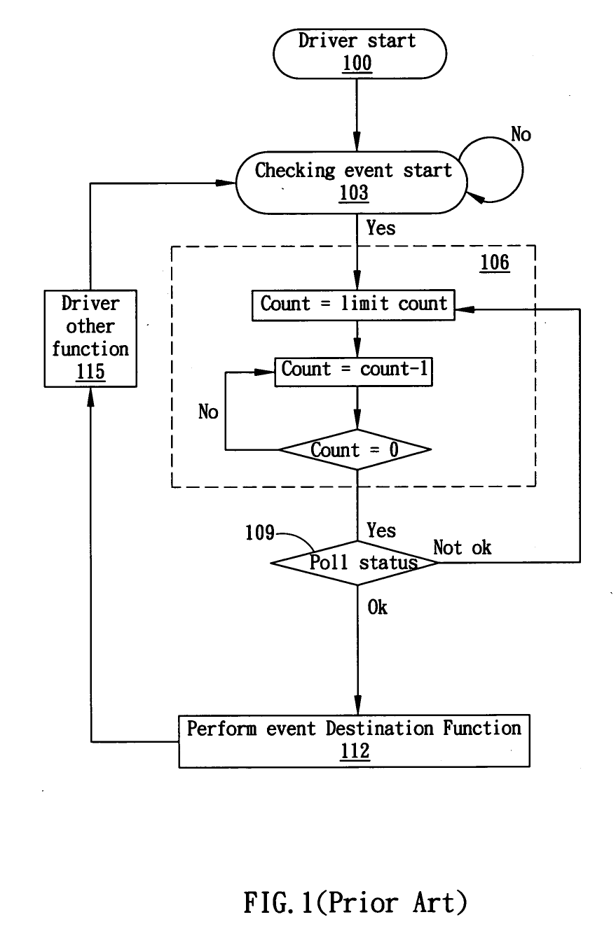

FIG. 2 shows an example illustrating vertical blanking and horizontal blanking.

FIG. 3 shows a flow chart according to one embodiment of the present invention.

### DESCRIPTION OF THE PREFERRED EMBODIMENT

Some exemplary embodiments of the invention would now be described in greater details. Nevertheless, it should be recognized that the present invention can be practiced in a wide range of other embodiments besides those explicitly described, and the scope of the present invention is expressly not limited except as specified in the accompanying claims.

A method for preventing the long latency event in the working procedure of the processor is disclosed. The method could temporarily release the computing resource of the processor in order to complete other works. Present method could be applied to any processor driver which has polling function.

Next, an embodiment of the present method is described. In the general computer system, the system would automatically reduce the working clock or working voltage for the CPU (central processing unit) when the works processed by the CPU are simple, so as to save the computing resource of the CPU. The change of the working clock or working voltage for the CPU should be determined carefully because the computer system is still working. Hence, it is important to appropriately determine the timing to change, so as to prevent the variation of the present works in the CPU.

For instance, if the computer system only performs the work of playing VCD without other works, the computer system wouldn't need all the computing resource of the CPU. Hence, the driver of the CPU would reduce the working clock or working voltage for the CPU in order to save the computing resource, which is called an event. When an event happens, the computer system should wait until a specific status is satisfied. In some status, the computer system could perform the reducing of the working clock or working voltage for the CPU. In present embodiment, one of the above-mentioned status refers that the display of the computer system is in the situation of “vertical blanking” or “horizontal blanking”.

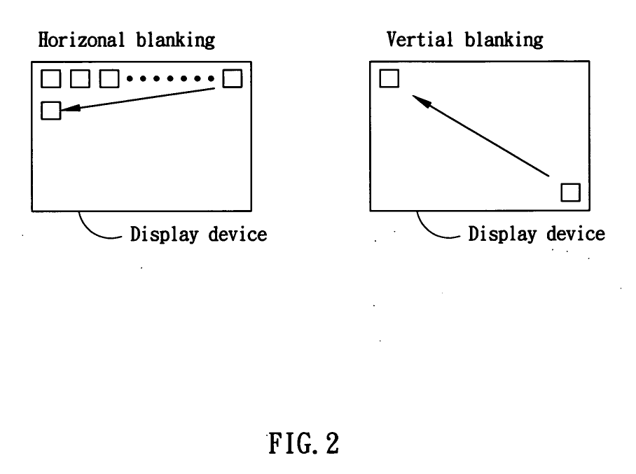

FIG. 2 shows an example of the vertical blanking and horizontal blanking. When a display show the first frame, the display would start at the first row. The first row is showed from the left to the right in order. Next, the display changes the showed position form the last pixel of the first row to the first pixel of the second row, which is called horizontal blanking. The display would not show anything during the horizontal blanking. The second row of the frame is showed from the left to the right, too. Finally, the frame would be totally showed until the last pixel of the last row. Before the showing of the next frame, the display would change the showed position from the last pixel of the first frame to the first pixel of the second frame, which is called vertical blanking.

During the horizontal blanking and the vertical blanking, it could be used to perform the event without defacing of the showed frame in the display. In present embodiment, the happening of the vertical blanking is defined as the happening of the status because it maintains the longer time. The application of the present method is not limited to the computer system. The foregoing called simple work is not limited to the playing of VCD. The event is not limited to the change of the working clock or working voltage for the CPU. The status is not limited to the happening of the vertical blanking.

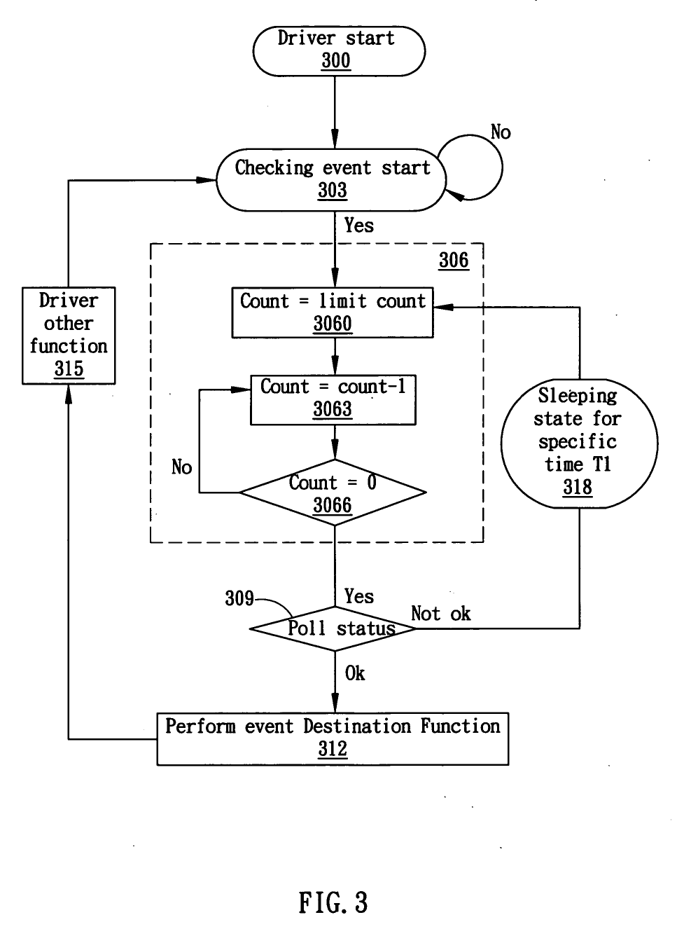

FIG. 3 shows the flow chart of the working procedure in the present invention. Present invention provides a method, which is capable of temporary releasing the computing resource of the processor. At first, the driver for driving the processor is enabled in step 300. In the step 303, the driver repeatedly checks whether an event happens or not, and then enters next step until the event has happened. In present embodiment, the event refers to the change of the working clock and working voltage for the processor in order to save the computing resource of the computer system. When the event has happened, the delay procedure 306 would be performed. The purpose of the delay procedure 306 is to make the processor to process a loop. The purpose of processing a loop is to wait for a time, and look forward to the happening of a status. The called status refers to an essential condition. The foregoing event should be performed when the status has happened. In present embodiment, the status refers to the happening of the vertical blanking.

The delay procedure 306 comprises the steps of: setting a defined value to a counter 3060, subtract 1 from the value in the counter 3063, checking whether the value in the counter is equal to 0 or not 3066. In the step 3066, the working procedure would return to the step 3063 if the value in the counter weren't equal to 0. The working procedure would enter the step 109 of polling status if the value in the counter were equal to 0 in the step 3066. If the status has happened in step 309, and then the step 312 would perform the event destination function to process the event by the processor. Next, the working procedure would enter the step 315 of processing driver other function, and then return to the step 303 finally.

However, if the status has not happened in the step 309 and then the working procedure would enter the step 318. A sleeping state for specific time T1 is performed in the step 318. The computing resource of the CPU would be released to process other works in the sleeping state for specific time T1, so as to prevent the long latency event. In present embodiment, the event of reducing the working clock or working voltage of the CPU happens when the computer system is playing VCD, but the work of playing VCD could be smooth even the vertical blanking doesn't happen yet. The reason is that the CPU could perform the work of playing VCD in the step 318.

According to the above-mentioned description, the method provided in present invention is capable of temporary releasing the computing resource of the CPU to process other works, so as to prevent the long latency event. The application of present method is not limited in the computer system, the method could be applied to any working procedure of driver as long as the driver has the polling function.

Although specific embodiments have been illustrated and described, it will be obvious to those skilled in the art that various modifications may be made without departing from what is intended to be limited solely by the appended claims.

What is claimed is:

1. A method for preventing the long latency event in the working procedure of the processor, said method comprising the steps of:
(a) repeatedly checking whether an event happens or not;
(b) performing a delay procedure during a first time duration when said event happens;
(c) checking whether a status happens or not; and
(d) performing a resource releasing procedure during a second time duration to a processor to process a first work when said status didn't happen in step (c), and then return to step (b).

2. The method according to claim 1, wherein said step (d) comprises performing an event destination function when said status happens in step (c).

3. The method according to claim 2, wherein said processor processes a second work after performing said event destination function.

4. The method according to claim 3, wherein comprises returning to step (a) after said processor processes said second work.

5. The method according to claim 1, wherein said delay procedure comprising the steps of:
(e) setting a defined value to a counter;
(f) subtract 1 from said value in said counter;
(g) checking whether said value in said counter is equal to 0 or not; and
(h) returning to step (g) when said value in said counter is not equal to 0.

6. The method according to claim 5, wherein comprises returning to step (c) when said value in said counter is not equal to 0 in step (g).

7. A method for preventing the long latency event in the working procedure of the processor, said method comprising the steps of:
(a) repeatedly checking whether an event happens or not;
(b) setting a defined value to a counter when said event happens;
(c) subtract 1 from said value in said counter;
(d) checking whether said value in said counter is equal to 0 or not;
(e) checking whether a status happens or not when said value in said counter is equal to 0 in step (d); and
(f) performing a resource releasing procedure during a second time duration to a processor to process a first work when said status didn't happen in step (e), and then return to step (b).

8. The method according to claim 7, wherein said step (f) comprises performing an event destination function when said status happens in step (e).

9. The method according to claim 8, wherein said processor processes a second work after performing said event destination function.

10. The method according to claim 9, wherein comprises returning to step (a) after said processor processes said second work.

11. The method according to claim 7, wherein comprises returning to step (c) when said value in said counter is not equal to 0 in step (d).

12. A method for preventing the long latency event in the working procedure of the processor, said method comprising the steps of:
(a) repeatedly checking whether an event happens or not;
(b) setting a defined value to a counter when said event happens;
(c) subtract 1 from said value in said counter;
(d) checking whether said value in said counter is equal to 0 or not;
(e) checking whether a status happens or not when said value in said counter is equal to 0 in step (d); and
(f) performing a resource releasing procedure during a second time duration to a processor to process a first work when said status didn't happen in step (e), and then return to step (b).
(g) performing an event destination function when said status happens in step (e).

13. The method according to claim 12, wherein said processor processes a second work after performing said event destination function.

14. The method according to claim 13, wherein comprises returning to step (a) after said processor processes said second work.

15. The method according to claim 12, wherein comprises returning to step (c) when said value in said counter is not equal to 0 in step (d).
